(19) United States
(12) Patent Application Publication
(10) Pub. No.: US 2026/0343344 A1
(43) Pub. Date: Oct. 29, 2026

(54) METHODS AND APPARATUSES OF SUPPORTING LTM CELL SWITCH

(71) Applicant: LENOVO (BEIJING) LIMITED, Beijing (CN)

(72) Inventors: Shuigen YANG, Shanghai (CN); Congchi ZHANG, Shanghai (CN); Le YAN, Shanghai (CN); Mingzeng DAI, Shanghai (CN); Lianhai WU, Beijing (CN); Bingchao LIU, Beijing (CN)

(21) Appl. No.: 19/111,595

(22) PCT Filed: Dec. 16, 2022
(86) PCT No.: PCT/CN2022/139749

§ 371 Date: Mar. 13, 2025

(51) Int. Cl. H04W 36/00; H04W 36/08

(52) U.S. Cl. CPC H04W 36/00725; H04W 36/0079; H04W 36/08

(57) ABSTRACT

The present application relates to of methods and apparatuses of supporting L1/L2-triggered mobility (LTM) cell switch. An embodiment of the present disclosure provides a user equipment (UE), which includes: a transceiver; and a processor coupled with the transceiver and configured to: obtain information indicating at least one candidate cell configuration, wherein each candidate cell is configured with at least one timer associated with random access channel (RACH) or RACH-skip; receive indication information associated with an LTM cell switch to a first candidate cell; and determine whether to perform an LTM cell switch with a RACH procedure or an LTM cell switch without a RACH procedure to the first candidate cell.

### TECHNICAL FIELD

The present disclosure relates to wireless communication, and particularly relates to methods and apparatuses of supporting L1/L2-triggered mobility (LTM) cell switch.

### BACKGROUND OF THE INVENTION

A user equipment (UE) may move from one cell to another cell, and thus at some points, a serving cell change needs to be performed.

At present, the serving cell change is performed by explicit radio resource control (RRC) reconfiguration signalling to trigger the synchronization of target cell based on layer 3 (L3) measurements report. It may lead to longer latency, larger overhead, and longer interruption time than beam level mobility.

In 3^{rd} generation partnership project (3GPP) Release 18, a new work item on further new radio (NR) mobility enhancements was approved to enable a serving cell change via lower layer signaling, e.g., layer 1 (L1) or layer 2 (L2) signalling, in order to reduce the latency, overhead and interruption time. During the LTM cell switch, failure may happen, therefore, it is necessary to detect the failure and handing the failure for LTM cell switch.

### SUMMARY

One objective of the present disclosure is to propose to some solutions of supporting LTM cell switch, e.g., solutions of failure detection and handling for LTM cell switch.

An embodiment of the present disclosure provides a UE, which includes: a transceiver; and a processor coupled with the transceiver and configured to: obtain information indicating at least one candidate cell configuration, wherein each candidate cell is configured with at least one timer associated with random access channel (RACH) or RACH-skip; receive indication information associated with an LTM cell switch to a first candidate cell; and determine whether to perform an LTM cell switch with a RACH procedure or an LTM cell switch without a RACH procedure to the first candidate cell.

In some embodiments, the processor is further configured to: start a first timer associated with RACH to perform the LTM cell switch with a RACH procedure to the first candidate cell.

In some embodiments, the processor is further configured to: start a second timer associated with RACH-skip to perform the LTM cell switch without a RACH procedure to the first candidate cell.

In some embodiments, the information includes at least one of the following: a first indicator indicating whether to apply a stored candidate cell configuration in the case that a candidate cell selected by the UE is an LTM candidate cell after a failure of at least one of the LTM cell switch with a RACH procedure or the LTM cell switch without a RACH procedure; a first timing advance (TA) value for each candidate cell corresponding to each of the at least one candidate cell configuration; or a RACH configuration for acquiring a second TA value for each candidate cell corresponding to each of the at least one candidate cell configuration.

In some embodiments, the indication information includes at least one of the following: a second TA value of the first candidate cell; a second indicator indicating whether to apply a stored candidate cell configuration in the case that a candidate cell selected by the UE is an LTM candidate cell after a failure of at least one of the LTM cell switch with a RACH procedure or the LTM cell switch without a RACH procedure; or a third indicator indicating a timer of the at least one timer associated with RACH or RACH-skip for the first candidate cell.

The UE of Claim 1, wherein the processor is further configured to: transmit, to a source distributed unit (DU), a failure of the LTM cell switch without a RACH procedure.

In some embodiments, the processor is further configured to: receive, from the source DU, a message indicating to perform the LTM cell switch with a RACH procedure to the first candidate cell.

In some embodiments, the processor is further configured to: apply a stored candidate cell configuration of a second candidate cell selected by the UE and perform an LTM cell switch to the second candidate cell in the case that a first indicator or a second indicator is received, wherein the first indicator or the second indicator indicates to apply the stored candidate cell configuration in the case that a candidate cell selected by the UE is an LTM candidate cell after a failure of at least one of the LTM cell switch with a RACH procedure or the LTM cell switch without a RACH procedure.

In some embodiments, the processor is further configured to: report at least one of the following: an identifier of the first candidate cell; an identifier of the second candidate cell selected by the UE; a fourth indicator indicating the LTM cell switch without a RACH procedure or the LTM cell switch with a RACH procedure is performed; or a fifth indicator indicating whether the LTM cell switch without a RACH procedure fallbacks to the LTM cell switch with a RACH procedure.

In some embodiments, the processor is further configured to: receive the second TA value for the first candidate cell from a corresponding candidate DU.

Another embodiment of the present disclosure provides a DU, which includes: a transceiver; and a processor coupled with the transceiver and configured to: transmit, to a UE, information indicating at least one candidate cell configuration, wherein each candidate cell is configured with at least one timer associated with RACH or RACH-skip for LTM cell switch; and transmit, to the UE, indication information indicating an LTM cell switch to a first candidate cell.

In some embodiments, a first timer associated with RACH is for performing the LTM cell switch with a RACH procedure to a first candidate cell.

In some embodiments, a second timer associated with RACH-skip is for performing the LTM cell switch without a RACH procedure to a first candidate cell.

In some embodiments, the information further indicates a first indicator indicating whether to apply a stored candidate cell configuration in the case that a candidate cell selected by the UE is an LTM candidate cell after a failure of at least one of the LTM cell switch with a RACH procedure or the LTM cell switch without a RACH procedure.

In some embodiments, the indication information indicates at least one of the following: a TA value for the first candidate cell; a second indicator indicating whether to apply a stored candidate cell configuration in the case that a candidate cell selected by the UE is an LTM candidate cell after a failure of at least one of a LTM cell switch with a RACH procedure to the first candidate cell or a LTM cell switch without a RACH procedure to the first candidate cell; or a third indicator indicating a timer of the at least one timer associated with RACH or RACH-skip for the first candidate cell.

In some embodiments, the processor is further configured to: receive, from the UE, a failure of the LTM cell switch without a RACH procedure.

In some embodiments, the processor is further configured to: transmit a message indicating the UE to perform the LTM cell switch with a RACH procedure to the first candidate cell.

In some embodiments, the processor is further configured to: transmit, to a central unit (CU), a response message indicating one or more candidate cell configurations associated with the DU; and receive, from the CU, the at least one candidate cell configuration.

In some embodiments, the processor is further configured to: receive, from a CU, a report which indicates at least one of the following: a type of the failure; an identifier of the first candidate cell; an identifier of a second candidate cell selected by the UE; a fourth indicator indicating the LTM cell switch with a RACH procedure or the LTM cell switch is performed without a RACH procedure; or a fifth indicator indicating whether a LTM cell switch without a RACH procedure fallbacks to the LTM cell switch with a RACH procedure.

Still another embodiment of the present disclosure provides a CU, which includes: a transceiver; and a processor coupled with the transceiver and configured to: receive, from one or more DUs, one or more candidate cell configurations, wherein each DU is associated with a set of candidate cell configurations; transmit, to a UE via a source DU, information indicating at least one candidate cell configuration for LTM cell switch, wherein each candidate cell is configured with at least one timer associated with RACH or RACH-skip for LTM cell switch.

In some embodiments, a first timer associated with RACH is for performing the LTM cell switch with a RACH procedure to a first candidate cell.

In some embodiments, a second timer associated with RACH-skip is for performing the LTM cell switch without a RACH procedure to a first candidate cell.

In some embodiments, the at least one timer is received from the one or more DUs, or is determined by the CU.

In some embodiments, the processor is further configured to: transmit a report of a failure of an LTM cell switch to a first candidate cell including at least one of the following: a type of the failure; an identifier of the first candidate cell; an identifier of a second candidate cell selected by the UE; a fourth indicator indicating the LTM cell switch with a RACH procedure to the first candidate cell or the LTM cell switch without a RACH procedure to the first candidate cell is performed; or a fifth indicator indicating whether the LTM cell switch without a RACH procedure fallbacks to the LTM cell switch with a RACH procedure.

In some embodiments, the processor is further configured to: receive a report of a failure of an LTM cell switch to a first candidate cell including at least one of the following: an identifier of the first candidate cell; an identifier of a second candidate cell selected by the UE; a fourth indicator indicating an LTM cell switch with a RACH procedure to the first candidate cell with a RACH procedure or the LTM cell switch without a RACH procedure to the first candidate cell is performed; or a fifth indicator indicating whether the LTM cell switch without a RACH procedure fallbacks to the LTM cell switch with a RACH procedure.

Still another embodiment of the present disclosure provides a DU, which includes: a transceiver; and a processor coupled with the transceiver and configured to: receive, from a CU, a request message; and transmit, to a CU, a response message indicating at least one of the following: at least one candidate cell configuration, wherein a candidate cell configuration corresponds to an LTM candidate cell; at least one timer associated with RACH or with RACH-skip for each LTM candidate cell; a first TA value for each LTM candidate cell; or a RACH configuration for acquiring a second TA value for each LTM candidate cell.

In some embodiments, a first timer associated with RACH is for performing an LTM cell switch with a RACH procedure to a first candidate cell.

In some embodiments, a second timer associated with RACH-skip is for performing an LTM cell switch without a RACH procedure to a first candidate cell.

In some embodiments, the processor is further configured to: transmit, to a CU, a report associated with a failure of an LTM cell switch to a first candidate cell including at least one of the following: an identifier of the first candidate cell; an identifier of a second candidate cell; a fourth indicator indicating the LTM cell switch with a RACH procedure to the first candidate cell or the LTM cell switch without a RACH procedure to the first candidate cell is performed; or a fifth indicator indicating whether the LTM cell switch without a RACH procedure fallbacks to the LTM cell switch with a RACH procedure.

In some embodiments, the processor is further configured to: receive, from a CU, a report associated with a failure of an LTM cell switch to a first candidate cell including at least one of the following: a type of the failure; an identifier of a second candidate cell selected by the UE; a fourth indicator indicating the LTM cell switch with a RACH procedure to the first candidate cell or the LTM cell switch without a RACH procedure to the first candidate cell is performed; or a fifth indicator indicating whether the LTM cell switch without a RACH procedure fallbacks to the LTM cell switch with a RACH procedure.

Still another embodiment of the present disclosure provides a method performed by UE, which includes: obtaining information indicating at least one candidate cell configuration, wherein each candidate cell is configured with at least one timer associated with RACH or with RACH-skip; receiving indication information associated with an LTM cell switch to a first candidate cell; and determining whether to perform an LTM cell switch with a RACH procedure to the first candidate cell or a LTM cell switch without a RACH procedure to the first candidate cell.

Still another embodiment of the present disclosure provides a method performed by a DU, which includes: transmitting, to a UE, information indicating at least one candidate cell configuration, wherein each candidate cell is configured with at least one timer associated with RACH or with RACH-skip for LTM cell switch; and transmitting, to the UE, indication information indicating an LTM cell switch to a first candidate cell.

Still another embodiment of the present disclosure provides a method performed by a CU, which includes: receiving, from one or more DUs, one or more candidate cell configurations, wherein each DU is associated with a set of candidate cell configuration; transmitting, to a UE via a source DU, information indicating at least one candidate cell configuration for LTM cell switch, wherein each candidate cell is configured with at least one timer associated with RACH or with RACH-skip for LTM cell switch.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1A illustrates a schematic diagram of an intra-CU intra-DU mobility scenario according to some embodiments of the present disclosure.

FIG. 1B illustrates a schematic diagram of an intra-CU inter-DU mobility scenario according to some embodiments of the present disclosure.

FIG. 2 illustrates a method performed by a UE of supporting LTM cell switch according to some embodiments of the present disclosure.

FIG. 3 illustrates a method performed by a DU of supporting LTM cell switch according to some embodiments of the present disclosure.

FIG. 4 illustrates a method performed by a CU of supporting LTM cell switch according to some embodiments of the present disclosure.

FIG. 5 illustrates a method performed by a DU of supporting LTM cell switch according to some embodiments of the present disclosure.

FIG. 6 illustrates a flow chart of a procedure of failure detection and handling for LTM cell switch according to some embodiments of the present disclosure.

FIG. 7 illustrates a flow chart of a procedure of failure detection and handling for LTM cell switch according to some embodiments of the present disclosure.

FIG. 8 illustrates a flow chart of a procedure of failure detection and handling for LTM cell switch according to some embodiments of the present disclosure.

FIG. 9 illustrates a simplified block diagram of an apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as a cellular telephone network, a time division multiple access (TDMA)-based network, a code division multiple access (CDMA)-based network, an orthogonal frequency division multiple access (OFDMA)-based network, an long-term evolution (LTE) network, a 3GPP-based network, LTE, LTE-Advanced (LTE-A), 3GPP 4G, 3GPP 5G NR, 3GPP Release 16 and onwards, a satellite communications network, a high altitude platform network, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

When the UE moves from one cell to another cell, at some point a serving cell of the UE may need to be changed. The change of the serving cell may be performed with an explicit RRC reconfiguration signalling(s), which may trigger the synchronization of target cell based on L3 measurements report. However, this approach may have longer latency, larger overhead, and longer interruption time than beam level mobility.

In 3GPP Release 18, a new work item on further NR mobility enhancements, which may be named as LTM was approved to enable a serving cell change via L1 or L2 signalling, to reduce the latency, overhead and interruption time. The potential applicable scenarios of LTM may include intra-CU intra-DU mobility and intra-CU inter-DU mobility.

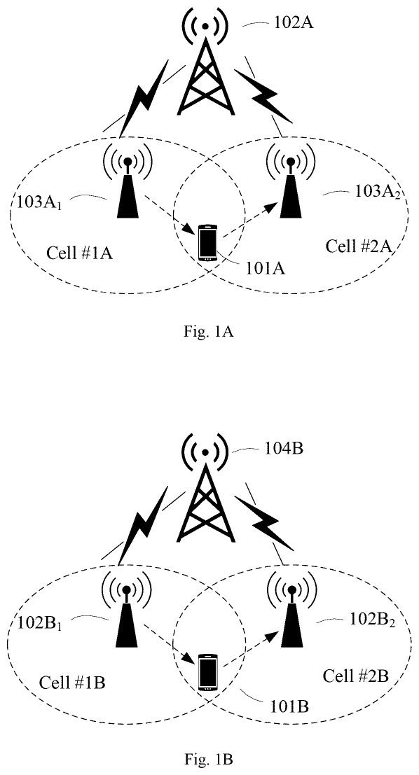

FIG. 1A illustrates a schematic diagram of an intra-CU intra-DU mobility scenario according to some embodiments of the present disclosure.

The wireless communication system in FIG. 1A includes a DU (e.g., DU 102A), a UE (e.g. UE 101A), and some access nodes (e.g. access node 103A₁ and access node 103A₂). The access node 103A₁ and access node 103A₂ are controlled by the DU 102A, and provides services for UEs within cell #1A and cell #2A respectively. Even though there are only one UE and two access nodes in FIG. 1A, persons skilled in the art will recognize that any number of UEs and access nodes may be included in the wireless communication system.

UE 101A may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, modems), or the like. According to an embodiment of the present disclosure, UE 101A may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, UE 101A includes wearable devices, such as smart watches, fitness bands, optical head-mounted displays, or the like. Moreover, UE 101A may be referred to as subscriber units, mobiles, mobile stations, users, terminals, mobile terminals, wireless terminals, fixed terminals, subscriber stations, user terminals, a device, or by other terminology used in the art.

The access nodes 103A₁ and 103A₂ may be distributed over a geographic region. In certain embodiments, a access node may also be referred to as an access point, an access terminal, a base, a base station, a macro cell, a node-B, an enhanced node B (eNB), a gNB, a home node-B, a relay node, a device, or by any other terminology used in the art. The access nodes 103A₁ and 103A₂ may be generally a part of a radio access network that may include one or more controllers communicably coupled to one or more corresponding base stations.

The wireless communication system is compliant with any type of network that is capable of sending and receiving wireless communication signals. For example, the wireless communication system is compliant with a wireless communication network, a cellular telephone network, a TDMA-based network, a CDMA-based network, an OFDMA-based network, an LTE network, a 3GPP-based network, 3GPP 5G network, a satellite communications network, a high altitude platform network, and/or other communications networks.

In one implementation, the wireless communication system is compliant with the NR of the 3GPP protocol, wherein the transmission may be performed using an OFDM modulation scheme. More generally, the wireless communication system may implement some other open or proprietary communication protocol, for example, WiMAX, among other protocols.

In other embodiments, the transmission may be performed using other communication protocols, such as the IEEE 802.11 family of wireless communication protocols. Further, in some embodiments the transmission may be performed over licensed spectrum, while in other embodiments the transmission may be performed over unlicensed spectrum. The present disclosure is not intended to be limited to the implementation of any particular wireless communication system architecture or protocol. In another embodiment, the transmission may be performed using the 3GPP 5G protocols.

In FIG. 1A, UE 101A is moving from cell #1A to cell #2A, and may perform a handover procedure from cell #1A to access to cell #2A, which is a handover procedure performed between different cells within a DU. This scenario may be referred to as intra-CU intra-DU mobility. In short, this scenario may be called as intra-DU mobility.

FIG. 1B illustrates a schematic diagram of an intra-CU inter-DU mobility scenario according to some embodiments of the present disclosure.

The wireless communication system in FIG. 1B includes a CU (e.g., CU 104B), a UE (e.g. UE 101B), and some DUs (e.g. DU 102B₁ and DU 102B₂). The DU 102B₁ and DU 102B₂ are controlled by CU 104B, and provides services for UEs within cell #1B and cell #2B respectively. Even though there are only one UE and two DUs in FIG. 1B, persons skilled in the art will recognize that any number of UEs and DUs may be included in the wireless communication system.

In FIG. 1B, UE #101B is moving from cell #1B to cell #2B, and may perform a handover procedure from cell #1B to access to cell #2B, which is a handover procedure performed between different cells belonging to different DUs but within the same CU. This scenario may be referred to as intra-CU inter-DU mobility. In short, this scenario may be called as inter-DU mobility.

During the serving cell change procedure, it may be important to determine the successful completion of cell change procedure. Hereinafter in the present disclosure, the LTM cell switch may also be referred to as an LTM cell handover, an LTM cell change, or the like. Persons skilled in the art are aware that these expressions may be used interchangeably.

For the LTM cell switch, the following issues need to be addressed:
Issue 1: At present, there is no timer for the LTM cell switch, and it follows that there is no start condition or stop condition for the timer(s) for the LTM cell switch. Hereinafter in the present disclosure, the timer may also be referred to as a timer value, a value of a timer, or the like.
Issue 2: Since there is no timer for the LTM cell switch, it is unclear what the UE behavior is when the timer(s) for the LTM cell switch expires.
Issue 3: The LTM cell switch may be initiated by the source DU, and the candidate cell configurations may be prepared by the candidate DU. When a failure occurred for the LTM cell switch, it is necessary to enable the source DU, the candidate DU(s), and/or the CU, to detect and handle the LTM radio link failure (RLF). That is, it is important to optimize the LTM cell switch decision and/or candidate cell configuration preparation.
Issue 4: At present, the UE does not know how to determine to perform an LTM cell switch with a RACH procedure or an LTM cell switch without a RACH procedure to the candidate cell. When LTM RLF happens, the UE does not know whether to apply the stored candidate cell configuration if the selected cell is an LTM candidate cell.

The present disclosure proposes some solutions for solving the above issues.

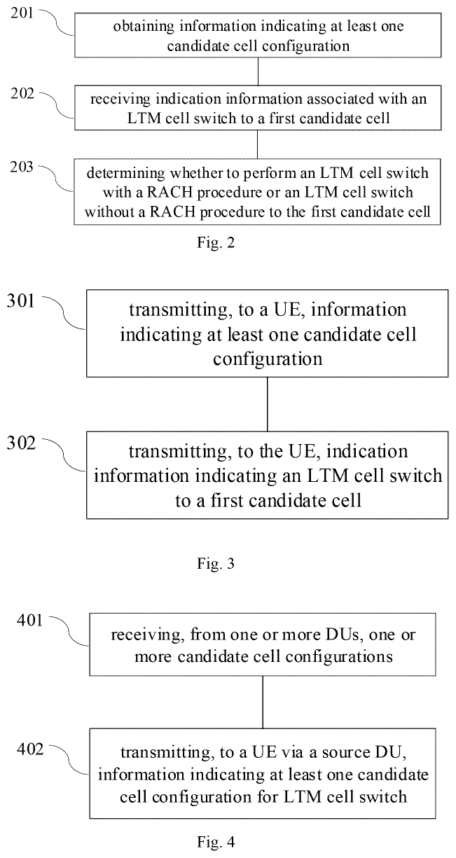

FIG. 2 illustrates a method performed by a UE according to some embodiments of the present disclosure.

In operation 201, the UE may obtain information indicating at least one candidate cell configuration, wherein each candidate cell is configured with at least one timer associated with RACH or RACH-skip. In operation 202, the UE may receive indication information associated with an LTM cell switch to a first candidate cell. In operation 203, the UE may determine whether to perform an LTM cell switch with a RACH procedure or an LTM cell switch without a RACH procedure to the first candidate cell. For example, the information may be indicated by the RRC RECONFIGURATION message, which is transmitted from the CU to the UE via the source DU. The indication information may be received from a source DU, and may be an LTM cell switch command.

In some embodiments, the UE may start a first timer associated with RACH to perform the LTM cell switch with a RACH procedure to the first candidate cell. In some other embodiments, the UE may start a second timer associated with RACH-skip to perform the LTM cell switch without a RACH procedure to the first candidate cell.

In some embodiments, the information, which is transmitted from the CU to the UE via the source DU, may include at least one of the following:
a first indicator indicating whether to apply a stored candidate cell configuration in the case that a candidate cell selected by the UE is an LTM candidate cell after a failure of at least one of the LTM cell switch with a RACH procedure or the LTM cell switch without a RACH procedure;
a first TA value for each candidate cell corresponding to each of the at least one candidate cell configuration; or
a RACH configuration for acquiring a second TA value for each candidate cell corresponding to each of the at least one candidate cell configuration.

In some embodiments, the indication information, which is transmitted to the UE from source DU, may include at least one of the following:
a second TA value of the first candidate cell;
a second indicator indicating whether to apply a stored candidate cell configuration in the case that a candidate cell selected by the UE is an LTM candidate cell after a failure of at least one of the LTM cell switch with a RACH procedure or the LTM cell switch without a RACH procedure; or
a third indicator indicating a timer of the at least one timer associated with RACH or RACH-skip for the first candidate cell.

In some embodiments, the UE may transmit, to a source DU, a failure of the LTM cell switch without a RACH procedure.

In some embodiments, the UE may receive, from the source DU, a message indicating to perform the LTM cell switch with a RACH procedure to the first candidate cell.

In some embodiments, the UE may apply a stored candidate cell configuration of a second candidate cell selected by the UE and perform an LTM cell switch to the second candidate cell in the case that a first indicator or a second indicator is received, wherein the first indicator or the second indicator indicates to apply the stored candidate cell configuration in the case that a candidate cell selected by the UE is an LTM candidate cell after a failure of at least one of the LTM cell switch with a RACH procedure or the LTM cell switch without a RACH procedure.

In some embodiments, the UE may report at least one of the following:
an identifier of the first candidate cell, such as the global cell identity of the first candidate cell;
an identifier of the second candidate cell selected by the UE;
a fourth indicator indicating the LTM cell switch without a RACH procedure or the LTM cell switch with a RACH procedure is performed; or
a fifth indicator indicating whether the LTM cell switch without a RACH procedure fallbacks to the LTM cell switch with a RACH procedure.

In some embodiments, the above information may be transmitted to a CU via the DU, the DU may be associated with the second candidate cell selected by the UE, which may include a source DU, or a candidate DU. Alternatively, the above information may be transmitted to a DU, and the DU may transmit the information to the CU.

In some embodiments, the UE may receive the second TA value for the first candidate cell from a corresponding candidate DU. That is, from the candidate DU that manages the first candidate cell.

FIG. 3 illustrates a method performed by a DU, e.g., a source DU according to some embodiments of the present disclosure.

In operation 301, the source DU may transmit, to a UE, information indicating at least one candidate cell configuration, wherein each candidate cell is configured with at least one timer associated with RACH or RACH-skip for LTM cell switch. In operation 302, the source DU may transmit, to the UE, indication information indicating an LTM cell switch to a first candidate cell. For example, the information may be indicated by the RRC RECONFIGURATION message, which is transmitted from the CU to the UE via the source DU. The indication information may be received from a source DU, and may be an LTM cell switch command.

In some embodiments, a first timer associated with RACH is for performing the LTM cell switch with a RACH procedure to a first candidate cell. In some embodiments, a second timer associated with RACH-skip is for performing the LTM cell switch without a RACH procedure to a first candidate cell.

In some embodiments, the information further indicates at least one first indicator, wherein each first indicator is associated with a corresponding one of the at least one candidate cell configuration and indicates whether to apply a stored candidate cell configuration in the case that a candidate cell selected by the UE is an LTM candidate cell after a failure of at least one of the LTM cell switch with a RACH procedure or the LTM cell switch without a RACH procedure.

In some embodiments, the indication information indicates at least one of the following:
a TA value for the first candidate cell;
a second indicator indicating whether to apply a stored candidate cell configuration in the case that a candidate cell selected by the UE is an LTM candidate cell after a failure of at least one of an LTM cell switch with a RACH procedure to the first candidate cell or an LTM cell switch without a RACH procedure to the first candidate cell; or
a third indicator indicating a timer of the at least one timer associated with RACH or RACH-skip for the first candidate cell.

In some embodiments, the source DU may receive, from the UE, a failure of the LTM cell switch without a RACH procedure. For example, an LTM RLF report.

In some embodiments, the source DU may transmit a message indicating the UE to perform the LTM cell switch with a RACH procedure to the first candidate cell.

In some embodiments, the source DU may transmit, to a CU, a response message indicating one or more candidate cell configurations associated with the DU; and receive, from the CU, the at least one candidate cell configuration.

In some embodiments, the source DU may receive, from a CU, a report which indicates at least one of the following:
a type of the failure, for example, too late LTM cell switch, Too early LTM cell switch, or LTM cell switch to a wrong cell, etc.
an identifier of the first candidate cell, such as the global cell identity of the first candidate cell;
an identifier of a second candidate cell selected by the UE;
a fourth indicator indicating the LTM cell switch with a RACH procedure or the LTM cell switch is performed without a RACH procedure; or
a fifth indicator indicating whether an LTM cell switch without a RACH procedure fallbacks to the LTM cell switch with a RACH procedure.

FIG. 4 illustrates a method performed by a CU according to some embodiments of the present disclosure.

In operation 401, the CU may receive, from one or more DUs, one or more candidate cell configurations, wherein each DU is associated with a set of candidate cell configurations. In operation 402, the CU may transmit, to a UE via a source DU, information indicating at least one candidate cell configuration for LTM cell switch, wherein each candidate cell is configured with at least one timer associated with RACH or RACH-skip for LTM cell switch.

In some embodiments, the at least one timer is received from the one or more DUs, or is determined by the CU.

In some embodiments, the CU may transmit a report of a failure of an LTM cell switch to a first candidate cell including at least one of the following:
a type of the failure;
an identifier of the first candidate cell, such as the global cell identity of the first candidate cell;
an identifier of a second candidate cell selected by the UE;
a fourth indicator indicating the LTM cell switch with a RACH procedure to the first candidate cell or the LTM cell switch without a RACH procedure to the first candidate cell is performed; or
a fifth indicator indicating whether the LTM cell switch without a RACH procedure fallbacks to the LTM cell switch with a RACH procedure.

In some embodiments, the CU may receive a report of a failure of an LTM cell switch to a first candidate cell including at least one of the following:
an identifier of the first candidate cell, such as the global cell identity of the first candidate cell;
an identifier of a second candidate cell selected by the UE;
a fourth indicator indicating an LTM cell switch with a RACH procedure to the first candidate cell with a RACH procedure or the LTM cell switch without a RACH procedure to the first candidate cell is performed; or
a fifth indicator indicating whether the LTM cell switch without a RACH procedure fallbacks to the LTM cell switch with a RACH procedure.

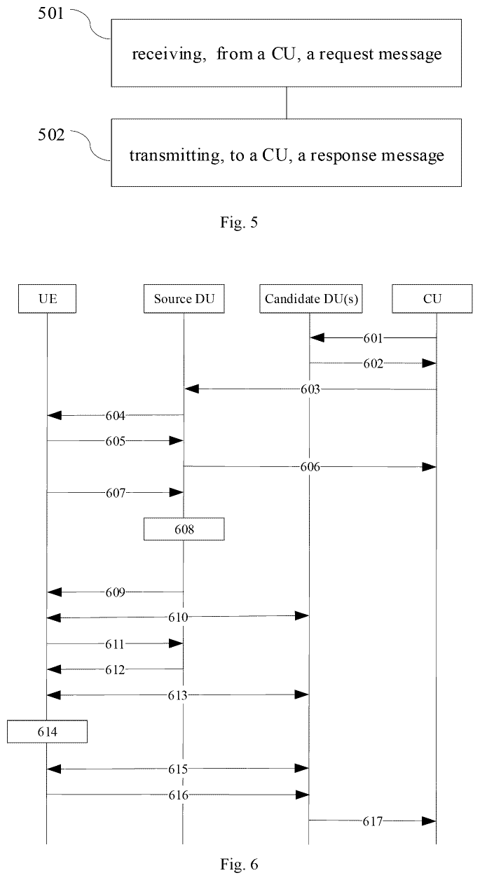

FIG. 5 illustrates a method performed by a DU, e.g. a candidate DU, according to some embodiments of the present disclosure.

In operation 501, the candidate DU may receive, from a CU, a request message; and in operation 502, the candidate DU may transmit, to a CU, a response message indicating at least one of the following:
at least one candidate cell configuration, wherein a candidate cell configuration corresponds to an LTM candidate cell;
at least one timer associated with RACH or with RACH-skip for each LTM candidate cell;
a first TA value for each LTM candidate cell; or
a RACH configuration for acquiring a second TA value for each LTM candidate cell.

In some embodiments, the candidate DU may transmit, to a CU, a report associated with a failure of an LTM cell switch to a first candidate cell including at least one of the following:
an identifier of the first candidate cell;
an identifier of a second candidate cell;
a fourth indicator indicating the LTM cell switch with a RACH procedure to the first candidate cell or the LTM cell switch without a RACH procedure to the first candidate cell is performed; or
a fifth indicator indicating whether the LTM cell switch without a RACH procedure fallbacks to the LTM cell switch with a RACH procedure.

In some embodiments, the candidate DU may receive, from a CU, a report associated with a failure of an LTM cell switch to a first candidate cell including at least one of the following:
a type of the failure, for example, too late LTM cell switch, Too early LTM cell switch, or LTM cell switch to a wrong cell, etc.
an identifier of a second candidate cell selected by the UE;
a fourth indicator indicating the LTM cell switch with a RACH procedure to the first candidate cell or the LTM cell switch without a RACH procedure to the first candidate cell is performed; or
a fifth indicator indicating whether the LTM cell switch without a RACH procedure fallbacks to the LTM cell switch with a RACH procedure.

FIG. 6 illustrates a flow chart of a procedure of failure detection and handling for LTM cell switch according to some embodiments of the present disclosure.

In FIG. 6, there are: a UE, a source DU (which may also be referred to a serving DU), one or more candidate DUs (which may also be referred to as “target DU(s),” “candidate target DU(s)” or “candidate DU(s)” in FIG. 6), and a CU. The source DU and the one or more candidate DUs are within the CU, and the UE is moving from the source DU to one of the one or more candidate DUs. The source DU may manage (or control) the serving cell of the UE, and one or more source cells. The serving cell and the one or more source cells are considered as in the source DU. Each candidate DU of the candidate DU(s) may manage one or more candidate cells, and the one or more candidate cells are considered as in each candidate DU. One of the one or more candidate DUs manages the candidate cell to which the UE is switched. In some embodiments, the candidate cell to which the UE is switched to may be referred to as the “target cell” or “candidate target cell.”

The handover manner, e.g. an LTM cell switch without a RACH procedure (or an LTM cell switch with a RACH-skip procedure) to the candidate cell, or an LTM cell switch with a RACH procedure to the candidate cell, may be determined by the source DU. The expression “RACH-skip” may also be referred to as RACH-less, non-RACH, no RACH or the like, which may refer to an access procedure to the candidate cell without a RACH procedure.

In operation 601, the UE may transmit a message, e.g. UE CONTEXT SETUP REQUEST message, indicating a number of candidate cell IDs (denoted as K candidate cell IDs for simplicity), to a candidate DU when the K candidate cells are managed by one candidate DU (or to multiple candidate DUs when the K candidate cells are controlled by multiple candidate DUs). Hereinafter, one candidate DU is used for describing the solutions, and persons skilled in the art are aware that the solutions can also be applied to a scenario where multiple candidate DUs are included. The message may request the preparation of K candidate cells controlled by the candidate DU(s), to create a UE context and setup one or more data bearers.

In some embodiments, the UE CONTEXT SETUP REQUEST message may be sent for each candidate cell. That is, the CU may transmit K UE CONTEXT SETUP REQUEST messages, where each UE CONTEXT SETUP REQUEST message may indicate a candidate cell ID.

In some other embodiments, the UE CONTEXT SETUP REQUEST message may include multiple candidate cell IDs (e.g., a list of K candidate cell IDs), and is transmitted to the candidate DU(s) which controls the multiple candidate cells.

In operation 602, the preparation request may be accepted, and the candidate DU may transmit a response message to the CU, for example, a UE CONTEXT SETUP RESPONSE message. The UE CONTEXT SETUP RESPONSE message may indicate the candidate cell ID(s) in the candidate DU that was requested by the CU, as well as the candidate cell configuration for each candidate cell.

The UE CONTEXT SETUP RESPONSE message may include at least one timer for the candidate cells, and each candidate cell may be associated with at least one timer. The at least one timer may be used for failure detection and handling for the UE, and there may be the following types of timers:
1. A timer for RACH. This timer may be used for LTM cell switch with a RACH procedure. Hereinafter, in the present disclosure, the timer for RACH may be referred to as the first timer. The UE CONTEXT SETUP RESPONSE message may indicate the timer value to be used during the LTM cell switch to the corresponding candidate cell using RACH-based mechanism. The timer value may be enumerated, e.g., 50 ms, 100 ms, 150 ms.
   Start condition of the timer for RACH: after successful reception of an LTM cell switch command, which may be received from the source DU, and may indicate the UE to perform an LTM cell switch with a RACH procedure. Alternatively, in the case that the UE may send a hybrid automatic repeat request-acknowledgement (HARQ-ACK) for the LTM cell switch command, the UE may start the timer used for RACH when the UE applies the LTM cell switch command.
   Stop condition of the timer for RACH: after successful completion of random access procedure to the corresponding candidate cell, e.g., when the MAC layer successfully completes the random access procedure.
2. A timer for RACH-skip. This timer may be used for LTM cell switch without a RACH procedure. Hereinafter in the present disclosure, the timer for RACH-skip may be referred to as the second timer. The UE CONTEXT SETUP RESPONSE message may indicate the timer value to be used during the LTM cell switch to the corresponding candidate cell using RACH-based mechanism. The timer value may be enumerated, e.g., 10 ms, 20 ms, 50 ms. Since the LTM cell switch is without a RACH procedure, the timer value for RACH-skip may be shorter than the timer value for RACH.
   Start condition of the timer for RACH-skip: after successful reception of an LTM cell switch command, which may be received from the source DU, and indicate the UE to perform an LTM cell switch without a RACH procedure. Alternatively, in the case that the UE may send a HARQ-ACK for the LTM cell switch command, the UE may start the timer used for RACH-skip when the UE applies the LTM cell switch command.
   Stop condition of the timer for RACH-skip: after successful completion of access procedure to the corresponding candidate cell, e.g., when the MAC indicates the successful reception of a physical downlink control channel (PDCCH) transmission addresses to cell radio network temporary Identifier (C-RNTI).

In some embodiments, the UE CONTEXT SETUP RESPONSE message may be sent for each candidate cell. That is, the candidate DU(s) may transmit K UE CONTEXT SETUP RESPONSE messages, where each UE CONTEXT SETUP RESPONSE message may indicate a candidate cell configuration and the corresponding timer(s), where the corresponding timers may include the first timer, the second timer, or both.

In some other embodiments, the UE CONTEXT SETUP RESPONSE message may include multiple candidate cell configurations and the corresponding timer(s). For example, a candidate DU may transmit all the candidate cell configurations and the corresponding timer(s) with one UE CONTEXT SETUP RESPONSE message.

In some cases, the UE CONTEXT SETUP RESPONSE message from the candidate DU(s) may only include the candidate cell configurations, but may not include the corresponding timer(s). The CU may determine the corresponding timer(s) for the corresponding candidate cell.

In operation 603, the CU may send a message, e.g. a DL RRC MESSAGE TRANSFER message (or a UE CONTEXT MODIFICATION REQUEST message, or other messages), to the source DU, which may include the candidate cell configurations, timer(s) and a generated RRC RECONFIGURATION message.

In the case that in operation 602, the candidate DU(s) has transmitted the timer(s) to the CU, the CU may incorporate these received timer(s) to the message, e.g. a DL RRC MESSAGE TRANSFER message, and to the generated RRC RECONFIGURATION message. These received timer(s) are per MAC layer, or may be referred to as per cell, and each candidate cell may be associated with its own corresponding timer(s). The timer(s) for different candidate cells may be different.

In the case that in operation 602, the candidate DU(s) has not transmitted the timer(s) to the CU, the CU may determine the timer(s) and may incorporate the determined timer(s) to the message, e.g. a DL RRC MESSAGE TRANSFER message, and to the RRC RECONFIGURATION message. The determined timer(s) are per RRC layer, and all the candidate cells have the same timer(s).

The RRC RECONFIGURATION message may further include one or more indicators (hereinafter referred to as the first indicator for clarity), which may indicate whether to apply the stored candidate cell configuration if the selected cell is an LTM candidate cell after a failure of the LTM cell switch, wherein the UE has stored the candidate cell configuration of the selected cell. For example, the one or more first indicators may be an enumerated value “true”, which indicates to apply the stored candidate cell configuration, or an enumerated value “false”, which indicates not to apply the stored candidate cell configuration. Other values, such as “1,” “0,” or the like, may also be used for indicating whether apply the stored candidate cell configuration if the selected cell is an LTM candidate cell after a failure of the LTM cell switch.

In some embodiments, there may be one first indicator in the RRC RECONFIGURATION message, and the first indicator may be applied to all the candidate cells.

In some other embodiments, there may be multiple first indicators, and each first indicator is associated with a candidate cell. When more than one candidate cell is associated with a first indicator with a value “true”, the UE may select one from the candidate cells based on UE implementation after a failure of the LTM cell switch.

In operation 604, the source DU may forward the message, e.g., the RRC RECONFIGURATION message to the UE, and the RRC RECONFIGURATION message may include: 1) the candidate cell configurations; and 2) the timer(s) associated with each candidate cell configuration. Additionally, the RRC RECONFIGURATION message may include one or more first indicators.

In operation 605, the UE may transmit a message, e.g. a RRC RECONFIGURATION COMPLETE message, as a response to the RRC RECONFIGURATION message, to the source DU.

In operation 606, the source DU may forward the RRC RECONFIGURATION COMPLETE message to the CU via an UL RRC MESSAGE TRANSFER message (or a UE CONTEXT MODIFICATION RESPONSE message, or other messages).

In operation 607, the UE may start to report the L1 measurements of serving cell, the source cell, and/or the candidate cells.

In operation 608, the source DU may determine that the LTM cell switch to a candidate cell is needed.

In operation 609, the source DU may send an LTM cell switch command to the UE, to trigger the UE to change from the current serving cell to a candidate cell, hereinafter, referred to as candidate cell 1 for clarity.

The LTM cell switch command may include an indicator (hereinafter referred to as a second indicator for clarity) which indicates whether to perform an LTM cell switch with a RACH procedure or an LTM cell switch without a RACH procedure to the candidate cell 1.

In some embodiments, the source DU may determine whether to perform the LTM cell switch with a RACH procedure or an LTM cell switch without a RACH procedure to the candidate cell 1 based on whether there is available TA for the candidate cell 1. In the case that source DU obtains the early TA for the candidate cell 1, the source DU may determine that the UE may perform an LTM cell switch without a RACH procedure to the candidate cell 1. The source DU may further include the TA value for candidate cell 1 in the LTM cell switch command. In the case that the source DU does not obtain the TA for the candidate cell 1, the source DU may determine that the UE may perform an LTM cell switch a RACH procedure to the candidate cell 1.

The second indicator may be separate from the TA value for the candidate cell 1. In other words, the second indicator and the TA value for the candidate cell 1 may be two different fields, two different indicators, or two different components, etc.

Alternatively, the second indicator may be the TA value for the candidate cell 1. That is, the TA value may be used to determine whether to perform an LTM cell switch with a RACH procedure or an LTM cell switch without a RACH procedure to the candidate cell 1. For example, if the TA value is set, e.g. with a value which is not zero, the UE may perform the LTM cell switch without a RACH procedure to the candidate cell 1. If the TA value is empty, e.g. with a value 0, the UE may perform a RACH procedure to the candidate cell 1.

The LTM cell switch command may include another indicator (hereinafter referred to as a third indicator for clarity), which may indicate whether to apply the stored candidate cell configuration if the selected cell is an LTM candidate cell after a failure of the LTM cell switch. For example, the third indicator may be an enumerated value “true”, which indicates to apply the stored candidate cell configuration, or an enumerated value “false”, which indicates not to apply the stored candidate cell configuration. Other values, such as “1,” “0,” or the like, may also be used for indicating whether apply the stored candidate cell configuration if the selected cell is an LTM candidate cell after a failure of the LTM cell switch.

In some embodiments, the LTM cell switch command may be a media access control control element (MAC CE) command, and the MAC CE may include at least one of the above-mentioned indicators: 1), the second indicator; 2) the TA value for the candidate cell 1; or 3) the third indicator.

In operation 610, the UE may perform an LTM cell switch to candidate cell 1.

The second indicator in the LTM cell switch command may indicate the UE to perform LTM cell switch with a RACH procedure to the candidate cell 1. Or, the second indicator may indicate that the TA value for the candidate cell 1 is 0, the UE may start the timer for RACH (which is associated with the candidate cell 1) after successful reception of LTM cell switch command, and may perform the random access procedure to the candidate cell 1 by initiating the preamble (that is, the first step of a RACH procedure). Alternatively, if the UE sends a HARQ-ACK for the LTM cell switch command in the physical layer, the UE will start the timer for RACH when the UE applies the LTM cell switch command.

Alternatively, the second indicator in the LTM cell switch command may indicate the UE to perform the LTM cell switch without a RACH procedure to the candidate cell 1. Or, the second indicator may indicate the TA value for the candidate cell 1 may be a non-zero value, the UE may start the timer for RACH-skip (which is associated with the candidate cell 1) after successful reception of LTM cell switch command, and may perform the access procedure to the candidate cell 1 by sending the initial physical uplink shared channel (PUSCH) transmission to the candidate cell 1 (that is, no RACH procedure). Alternatively, in the case that the UE may send a HARQ-ACK for the LTM cell switch command in the physical layer, the UE may start the timer for RACH-skip when the UE applies the LTM cell switch command.

During the LTM cell switch to candidate cell 1, the UE may determine whether the LTM cell switch is successful.

For the LTM cell switch with a RACH procedure to the candidate cell 1, when the random access on the candidate cell 1 is successfully completed, the UE may stop the timer for RACH. For example, when the MAC layer successfully completes the random access procedure, the UE may stop the timer for RACH.

For the LTM cell switch without a RACH procedure to the candidate cell 1, if the RACH-skip based access on the candidate cell 1 is successfully completed, the UE may stop the timer for RACH-skip. For example, when the MAC layer indicates the successful reception of a PDCCH transmission addresses to Cell Radio Network Temporary Identifier (C-RNTI) for the candidate cell 1, and the UE may stop the timer for RACH-skip.

Otherwise, when the timer (the timer for RACH or the timer for RACH-skip) expires, the UE may determine the LTM cell switch has failed.

Due to different types of failure, the UE may take different operations.

Case 1: the UE performs the LTM cell switch without a RACH procedure to the candidate cell 1, and the LTM cell switch without a RACH procedure failed, the UE may perform the following operations 611-613.

In operation 611, the UE may inform the source DU about the LTM cell switch failure information via a MAC CE.

In operation 612, the source DU may send another LTM cell switch command (that is, an LTM cell switch command different from the LTM cell switch command in operation 609) to the UE, which may trigger the UE to perform the LTM cell switch with a RACH procedure from the current serving cell to the candidate cell 1. That is, the LTM cell switch without a RACH procedure fallbacks to the LTM switch with a RACH procedure.

The LTM cell switch command may include the second indicator. The value of the second indicator may be set with the value which indicates the UE to perform the LTM cell switch a RACH procedure to the candidate cell 1.

The LTM cell switch command may include a third indicator, which may indicate whether to apply the stored candidate cell configuration if the selected cell is an LTM candidate cell after a failure of the LTM cell switch. For example, the third indicator may be an enumerated value “true”.

In some embodiments, the LTM cell switch command may be a MAC CE command, and the MAC CE may include at least one of the above-mentioned indicators: 1) the second indicator; or 2) the third indicator.

In operation 613, the UE may perform access procedure to candidate cell 1 using RACH based mechanism, e.g. the LTM cell switch with a RACH procedure.

Case 2: the UE performs the LTM cell switch with a RACH procedure to the candidate cell 1, and the LTM cell switch with a RACH procedure failed. Furthermore, the UE has received the third indicator, which indicates to apply the stored candidate cell configuration if the selected cell is an LTM candidate cell after a failure of the LTM cell switch. For example, the third indicator may be an enumerated value “true”. The UE may perform the following operations 614 and 615.

In operation 614, the LTM cell switch with a RACH procedure has failed, e.g. the UE has performed a RACH procedure to the candidate cell 1 and the timer for RACH has expired. The UE may perform a cell selection procedure to select a suitable cell. In the case that the selected cell (hereinafter referred to as candidate cell 2 for clarity) is an LTM candidate cell, based on the third indicator, the UE may apply the stored candidate cell configuration corresponding to the selected cell.

Otherwise, the UE may initiate the RRC re-establishment procedure.

In operation 615, the UE may perform an access procedure to the candidate cell 2.

In operation 616, the UE may send the LTM RLF report to the candidate DU that manages the candidate cell 2.

The LTM RLF report may include at least one of the following:
an identifier of the candidate cell selected by the UE, e.g. candidate cell 2, which may indicate the candidate cell for LTM that the UE selected for LTM based recovery, e.g., the ID of candidate cell 2. The UE may set the LTM cell ID of candidate cell 2 to the global cell identity of candidate cell 2 if available, otherwise, to the physical cell identity and carrier frequency of candidate cell 2.
the identifier of the failed candidate cell 1, e.g., the global cell identity or the physical cell identity and carrier frequency.
the access mechanism to the failed candidate cell 1, e.g., with a RACH procedure, or without a RACH procedure.
a fifth indicator, which indicates whether the LTM cell switch LTM cell switch without a RACH procedure to candidate cell 1 fallbacks to the LTM cell switch with a RACH procedure during the access procedure to candidate cell 1.

In operation 617, the candidate DU may forward the LTM RLF report to the CU, e.g., via an UL RRC MESSAGE TRANSFER message.

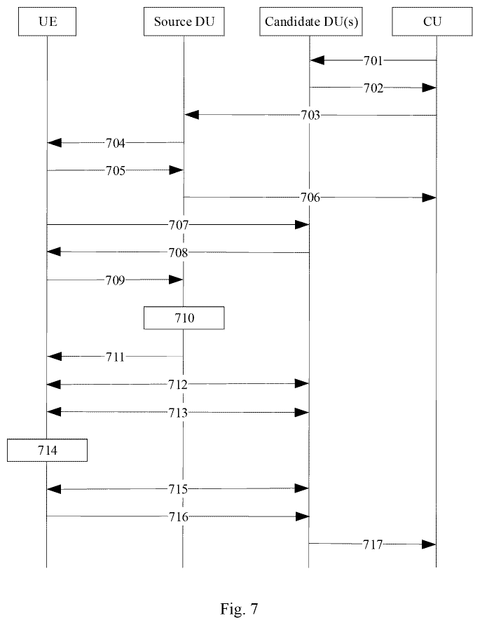

FIG. 7 illustrates a flow chart of a procedure of failure detection and handling for LTM cell switch according to some other embodiments of the present disclosure.

FIG. 7 includes the same components as described in FIG. 6, and details are omitted here.

The handover manner, e.g. an LTM cell switch without a RACH procedure (or an LTM cell switch with a RACH-skip procedure) to the candidate cell, or an LTM cell switch with a RACH procedure to the candidate cell, may be determined by the UE itself.

Operation 701 is similar to operation 601 as described in FIG. 6, and details are omitted here

In operation 702, the preparation request may be accepted, and the candidate DU(s) may transmit a response message to the CU, for example, a UE CONTEXT SETUP RESPONSE message. In addition to the content included in the UE CONTEXT SETUP RESPONSE message, e.g., 1) the candidate cell ID(s) that was requested from the CU; 2) the candidate cell configuration for each candidate cell; and 3) the timers for each candidate cell, including a timer for RACH and/or a timer for RACH-skip, which are similar to the UE CONTEXT SETUP RESPONSE message as described in operation 602 in FIG. 6, the UE CONTEXT SETUP RESPONSE message may further include: 4) the first TA for each candidate target cell; and/or 5) a RACH configuration for acquiring a second TA for each candidate target cell. The value of the first TA may be 100 ms, or the like, and the value of the second TA may be 20 ms, or the like.

The RACH configuration for acquiring a second TA for each candidate target cell may include at least one of following:
A RACH occasion: indicating time-frequency domain resource(s) for preamble transmission.
An synchronization signals and physical broadcast channels (SS/PBCH) index: indicating the SS/PBCH that may be used to determine the RACH occasion for the PRACH transmission.
A physical random access channel (PRACH) mask index: indicating the RACH occasion associated with the SS/PBCH indicated by “SS/PBCH index” for the PRACH transmission.

In some embodiments, the UE CONTEXT SETUP RESPONSE message may be sent for each candidate cell. That is, the CU may transmit K UE CONTEXT SETUP RESPONSE messages, where each UE CONTEXT SETUP RESPONSE message may indicate a candidate cell configuration and the corresponding timer(s), where the corresponding timers may include the first timer, the second timer, or both.

In some other embodiments, the UE CONTEXT SETUP RESPONSE message may include multiple candidate cell configurations and the corresponding timer(s).

In some cases, the UE CONTEXT SETUP RESPONSE message from the candidate DU(s) may only include the candidate cell configurations, but may not include the corresponding timer(s). The CU may determine the corresponding timer(s) for the corresponding candidate cell.

In operation 703, the CU may send a message, e.g. a DL RRC MESSAGE TRANSFER message (or a UE CONTEXT MODIFICATION REQUEST message, or other messages), to the source DU, which may include the candidate cell configurations and a generated RRC RECONFIGURATION message. In some cases, the DL RRC MESSAGE TRANSFER message may also include the timer(s) associated with each candidate cell configuration.

In operation 704, the source DU may forward the message, e.g., the RRC RECONFIGURATION message to the UE, and the RRC RECONFIGURATION message may include: 1) the candidate cell configurations; and 2) the timer(s) associated with each candidate cell configuration.

In the case that in operation 702, the candidate DU(s) has transmitted the timer(s) to the CU, the CU may incorporate these received timer(s) to the generated RRC RECONFIGURATION message. These received timer(s) are per MAC layer, or may be referred to as per cell, and each candidate cell may be associated with its own corresponding timer(s). The timer(s) for different candidate cells may be different.

In the case that in operation 702, the candidate DU(s) hasn't transmitted the timer(s) to the CU, the CU may determine the timer(s) and may incorporate the determined timer(s) to the generated RRC RECONFIGURATION message. The determined timer(s) are per RRC layer, and all the candidate cells have the same timer(s).

The RRC RECONFIGURATION message may further include one or more first indicators, which may indicate whether to apply the stored candidate cell configuration if the selected cell is an LTM candidate cell after a failure of the LTM cell switch, wherein the UE has stored the candidate cell configuration of the selected cell. For example, the one or more first indicators may be an enumerated value “true”, which indicates to apply the stored candidate cell configuration, while an enumerated value “false”, which indicates not to apply the stored candidate cell configuration. Other values, such as “1,” “0,” or the like, may also be used for indicating whether apply the stored candidate cell configuration if the selected cell is an LTM candidate cell after a failure of the LTM cell switch.

In some embodiments, there may be one first indicator in the RRC RECONFIGURATION message, the first indicator may be applied to all the candidate cells.

In some other embodiments, there may be multiple first indicators, and each first indicator is associated with a candidate cell. When more than one candidate cells are associated with a first indicator with a value “true”, the UE may select one from the candidate cells based on UE implementation after a failure of the LTM cell switch.

The RRC RECONFIGURATION message may further include the first TA for each candidate target cell (which is received from the candidate DU(s) in operation 702), and/or the RACH configuration for acquiring a second TA for each candidate target cell (which is received from the candidate DU(s)in operation 702).

In operation 705, the UE may transmit a message, e.g. a RRC RECONFIGURATION COMPLETE message, as a response to the RRC RECONFIGURATION message, to the source DU.

In operation 706, the source DU may forward the RRC RECONFIGURATION COMPLETE message to the CU via an UL RRC MESSAGE TRANSFER message (or a UE CONTEXT MODIFICATION RESPONSE message, or other messages).

In some embodiments, the UE may use the first TA of a candidate cell for accessing to the candidate cell. In some other embodiments, the first TA may not be so accurate, for example, the location of the UE has changed a lot since receiving the first TA, and thus the UE may acquire a second TA for the candidate cell based on the RACH configuration for acquiring a second TA for each candidate target cell. More specifically, the UE may perform operations 707 and 708. In operation 707, the UE may send a random access preamble to some or all of the target cells in the candidate DU(s), e.g., the candidate cell 1. In operation 708, the candidate DU(s) may send a second TA for the requested candidate target cell to the UE.

In operation 709, the UE may start to report the L1 measurements of serving cell, the source cell, and/or the candidate cells.

In operation 710, the source DU may determine that the LTM cell switch to a candidate cell is needed.

In operation 711, the source DU may send an LTM cell switch command, for example, a MAC CE command, to the UE, to trigger the UE to change from the current serving cell to the candidate cell 1.

After receiving the LTM cell switch command, the UE may determine whether to perform an LTM cell switch with a RACH procedure or an LTM cell switch without a RACH procedure to the candidate cell 1.

In the case that the RRC RECONFIGURATION message, which is transmitted to the UE in operation 704, includes the first TA for candidate cell 1, or the UE obtains the second TA for candidate cell 1 in operation 708, or the UE obtains both the first TA and the second TA for candidate cell 1, the UE may determine to perform LTM cell switch without a RACH procedure to the candidate cell. Otherwise, the UE may determine to perform an LTM cell switch with a RACH procedure to the candidate cell 1.

In the case that the UE determines to perform an LTM cell switch without a RACH procedure, in operation 712, the UE may perform an LTM cell switch without a RACH procedure to the candidate cell 1.

The UE may start the timer for RACH-skip (which is associated with the candidate cell 1) after successful reception of LTM cell switch command, and may perform the access procedure to the candidate cell 1 by sending the initial physical uplink shared channel (PUSCH) transmission to the candidate cell 1 (that is, no RACH procedure). Alternatively, in the case that the UE may send a HARQ-ACK for the LTM cell switch command in physical layer, the UE may start the timer for RACH-skip when the UE applies the LTM cell switch command.

During the LTM cell switch without a RACH procedure to candidate cell 1, the UE may determine whether the LTM cell switch has completed successfully. For example, when the MAC layer indicates the successful reception of a PDCCH transmission addresses to C-RNTI for the candidate cell 1, the UE may stop the timer for RACH-skip and determine that the LTM cell switch has completed successfully.

Otherwise, when the timer (the timer for RACH or the timer for RACH-skip) expires, the UE may determine the LTM cell switch has failed. The UE may perform operation 713, e.g. an LTM cell switch with a RACH procedure. That is, the LTM cell switch without a RACH procedure fallbacks to the LTM switch with a RACH procedure. In some embodiments, the UE may perform operation 714 directly without performing operation 713.

In operation 713, the UE may determine to perform an LTM cell switch with a RACH procedure to the candidate cell 1. The LTM cell switch with a RACH procedure may be performed due to a failure of the LTM cell switch without a RACH procedure, or due to lacking the TA of the candidate cell 1.

The UE may start the timer for RACH (which is associated with the candidate cell 1) after successful reception of LTM cell switch command, and may perform the access procedure to the candidate cell 1 by initiating the preamble. Alternatively, in the case that the UE may send a HARQ-ACK for the LTM cell switch command in physical layer, the UE may start the timer for RACH when the UE applies the LTM cell switch command.

During the LTM cell switch with a RACH procedure to candidate cell 1, the UE may determine whether the LTM cell switch is successful.

For the LTM cell switch with a RACH procedure to the candidate cell 1, when the random access on the candidate cell 1 is successfully completed, the UE may stop the timer for RACH. For example, when the MAC layer successfully completes the random access procedure, the UE may stop the timer for RACH.

Otherwise, when the timer for RACH has expired, the UE may determine that the LTM cell switch with a RACH procedure has failed.

In some embodiments, the first indicator, which is received in the operation 704, indicates to apply the stored candidate cell configuration if the selected cell is an LTM candidate cell after a failure of the LTM cell switch. For example, the first indicator may be an enumerated value “true”. The UE may perform operation 714.

Operations 714-717 are similar to operations 614-617 as described in FIG. 6 respectively, and details are omitted here.

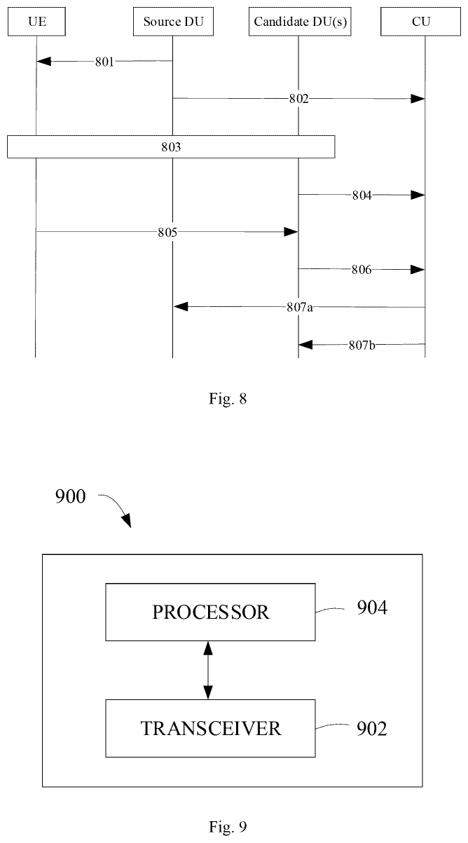

FIG. 8 illustrates a flow chart of a procedure of failure detection and handling for LTM cell switch according to some yet other embodiments of the present disclosure.

FIG. 8 includes the same components as described in FIG. 6, and details are omitted here.

In operation 801, the source DU may send an LTM cell switch command to the UE, to trigger the UE to change from the current serving cell to the candidate cell 1. The detailed description is similar to that of operation 609 as described in FIG. 6 or operation 711 in FIG. 7, and details are omitted here.

In operation 802, the source DU may send the LTM switch command report to the CU, which indicates the LTM switch command has been sent to the UE. In some other embodiments, the source DU may not transmit such a report to the CU. The LTM switch command report may include the candidate target cell identity that the LTM cell switch was initiated toward, e.g., the identity of candidate cell 1.

In operation 803, the UE may perform the access procedure to the candidate target cell 1. The detailed description is similar to that of operations 610 to 615 in FIG. 6, and details are omitted here.

In operation 804, the candidate DU, which manages the cell that is currently providing service to the UE, may transmit a message, e.g. an access success message, to the CU, which may indicate the CU that the UE has successfully accessed to the candidate cell. The message may indicate the identity of the candidate cell, e.g. candidate target cell 2. Alternatively, the candidate DU may not transmit the message to the CU.

In operation 805, the UE may transmit an LTM RLF report to the candidate DU. The detailed description is similar to the LTM RLF report of operation 616 in FIG. 6, and details are omitted here. Alternatively, the UE may not transmit the LTM RLF report to the candidate DU.

In operation 806, the candidate DU may forward the LTM RLF report to the CU, e.g., via an UL RRC MESSAGE TRANSFER message. Alternatively, the candidate DU may not transmit the LTM RLF report to the CU.

In operation 807a and operation 807b, the CU may determine the problem(s) during the LTM cell switch, and may send a message, e.g. a LTM handover report to the source DU in operation 807a and/or to the candidate DU in operation 807b.

The LTM handover report may include at least one of the following:
1. a type of the failure;
   The types of failure may include the following:
   i. Too late LTM cell switch: a radio link failure occurs after the UE has stayed for a long period of time in the source cell at the source DU; and the UE attempts to re-establish the radio link connection in a different cell for LTM.
   ii. Too early LTM cell switch: a radio link failure occurs shortly after a successful LTM cell switch from a source cell to a candidate target cell or an LTM cell switch failure occurs during the LTM procedure; and the UE attempts to re-establish the radio link connection in the source cell at the source DU.
   iii. LTM cell switch to a wrong cell: a radio link failure occurs shortly after a successful LTM cell switch from a source cell to a candidate target cell or an LTM cell switch failure occurs during the LTM procedure; and the UE attempts to re-establish the radio link connection in a cell other than the source cell and the candidate target cell.
2. The content in the LTM RLF report, which may be received from the UE via the candidate DU, which may include at least one the following:
   i. an identifier of the first candidate cell, such as the global cell identity of the first candidate cell;
   ii. an identifier of a second candidate cell selected by the UE;
   iii. an indicator indicating the LTM cell switch with a RACH procedure to the first candidate cell or the LTM cell switch without a RACH procedure to the first candidate cell is performed; or
   iv. an indicator indicating whether the LTM cell switch without a RACH procedure fallbacks to the LTM cell switch with a RACH procedure.

FIG. 9 illustrates a simplified block diagram of an apparatus according to some embodiments of the present disclosure.

As shown in FIG. 9, an example of the apparatus 900 may include at least one processor 904 and at least one transceiver 902 coupled to the processor 904. The apparatus 900 may be a UE, a BS, a CU, a candidate DU, a source DU, a target DU, or any other device with similar functions.

Although in this figure, elements such as the at least one transceiver 902 and processor 904 are described in the singular, the plural is contemplated unless a limitation to the singular is explicitly stated. In some embodiments of the present disclosure, the transceiver 902 may be divided into two devices, such as a receiving circuitry and a transmitting circuitry. In some embodiments of the present disclosure, the apparatus 900 may further include an input device, a memory, and/or other components.

In some embodiments of the present disclosure, the apparatus 900 may be a UE. The transceiver 902 and the processor 904 may interact with each other so as to perform the operations of the UE described in any of FIGS. 1-8. In some embodiments of the present disclosure, the apparatus 900 may be a CU, a candidate DU, a source DU, a target DU, or the like. The transceiver 902 and the processor 904 may interact with each other so as to perform the operations of the CU or DU(s) described in any of FIGS. 1-8.

In some embodiments of the present disclosure, the apparatus 900 may further include at least one non-transitory computer-readable medium.

For example, in some embodiments of the present disclosure, the non-transitory computer-readable medium may have stored thereon computer-executable instructions to cause the processor 904 to implement the method with respect to the UE as described above. For example, the computer-executable instructions, when executed, cause the processor 904 interacting with transceiver 902 to perform the operations of the UE described in any of FIGS. 1-8.

In some embodiments of the present disclosure, the non-transitory computer-readable medium may have stored thereon computer-executable instructions to cause the processor 904 to implement the method with respect to a CU, a candidate DU, a source DU, a target DU, or a candidate DU as described above. For example, the computer-executable instructions, when executed, cause the processor 904 interacting with transceiver 902 to perform the operations of the CU or DU(s) described in any of FIGS. 1-8.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “including.”

1. A user equipment (UE) for wireless communication, comprising:
at least one memory; and
at least one processor coupled with the at least one memory and configured to cause the UE to:
obtain information indicating at least one candidate cell configuration, wherein each candidate cell is configured with at least one timer associated with a random access channel (RACH) or a RACH-skip;
receive indication information associated with an L1/L2-triggered mobility (LTM) cell switch to a first candidate cell; and
determine whether to perform an LTM cell switch with a RACH procedure or an LTM cell switch without a RACH procedure to the first candidate cell.

2. The UE of claim 1, wherein the at least one processor is further configured to cause the UE to:
start a first timer associated with the RACH to perform the LTM cell switch with the RACH procedure to the first candidate cell.

3. 1. The UE of claim 1, wherein the at least one processor is further configured to cause the UE to:
start a second timer associated with the RACH-skip to perform the LTM cell switch without the RACH procedure to the first candidate cell.

4. The UE of claim 1, wherein the information includes at least one of the following:
a first indicator indicating whether to apply a stored candidate cell configuration when a candidate cell selected by the UE is an LTM candidate cell after a failure of at least one of the LTM cell switch with the RACH procedure or the LTM cell switch without the RACH procedure;
a first timing advance (TA) value for each candidate cell corresponding to each of the at least one candidate cell configuration; or
a RACH configuration for acquiring a second TA value for each candidate cell corresponding to each of the at least one candidate cell configuration.

5. The UE of claim 4, wherein the indication information includes at least one of the following:
a second TA value of the first candidate cell;
a second indicator indicating whether to apply a stored candidate cell configuration when a candidate cell selected by the UE is an LTM candidate cell after a failure of at least one of the LTM cell switch with the RACH procedure or the LTM cell switch without the RACH procedure; or
a third indicator indicating a timer of the at least one timer associated with the RACH or the RACH-skip for the first candidate cell.

6. The UE of claim 1, wherein the at least one processor is further configured to cause the UE to:
transmit, to a source distributed unit (DU), a failure of the LTM cell switch without the RACH procedure.

7. The UE of claim 1, wherein the at least one processor is further configured to cause the UE to:
apply a stored candidate cell configuration of a second candidate cell selected by the UE and perform an LTM cell switch to the second candidate cell when a first indicator or a second indicator is received, wherein the first indicator or the second indicator indicates to apply the stored candidate cell configuration when a candidate cell selected by the UE is an LTM candidate cell after a failure of at least one of the LTM cell switch with the RACH procedure or the LTM cell switch without the RACH procedure.

8. The UE of claim 7, wherein the at least one processor is further configured to cause the UE to:
report at least one of the following:
an identifier of the first candidate cell;
an identifier of the second candidate cell selected by the UE;
a fourth indicator indicating the LTM cell switch without the RACH procedure or the LTM cell switch with the RACH procedure is performed; or
a fifth indicator indicating whether the LTM cell switch without the RACH procedure fallbacks to the LTM cell switch with the RACH procedure.

9. The UE of claim 3, wherein the at least one processor is further configured to cause the UE to:
receive the second TA value for the first candidate cell from a corresponding candidate distributed unit (DU).

10. A distributed unit (DU) for wireless communication, comprising:
at least one memory; and
at least one processor coupled with the at least one memory and configured to cause the DU to:
transmit, to a user equipment (UE), information indicating at least one candidate cell configuration, wherein each candidate cell is configured with at least one timer associated with a random access channel (RACH) or a RACH-skip for an L1/L2-triggered mobility (LTM) cell switch; and
transmit, to the UE, indication information indicating an LTM cell switch to a first candidate cell.

11. The DU of claim 10, wherein the information further indicates a first indicator indicating whether to apply a stored candidate cell configuration when a candidate cell selected by the UE is an LTM candidate cell after a failure of at least one of the LTM cell switch with a RACH procedure or the LTM cell switch without a RACH procedure.

12. The DU of claim 10, wherein the indication information indicates at least one of the following:
a timing advance (TA) value for the first candidate cell;
a second indicator indicating whether to apply a stored candidate cell configuration when a candidate cell selected by the UE is an LTM candidate cell after a failure of at least one of an LTM cell switch with a RACH procedure to the first candidate cell or an LTM cell switch without a RACH procedure to the first candidate cell; or
a third indicator indicating a timer of the at least one timer associated with the RACH or the RACH-skip for the first candidate cell.

13. The DU of claim 12, wherein the at least one processor is further configured to cause the DU to:
receive, from the UE, a failure of the LTM cell switch without the RACH procedure.

14. The DU of claim 12, wherein the at least one processor is further configured to cause the DU to:
receive, from a central unit (CU), a report that indicates at least one of the following:
a type of the failure;
an identifier of the first candidate cell;
an identifier of a second candidate cell selected by the UE;
a fourth indicator indicating the LTM cell switch with the RACH procedure or the LTM cell switch is performed without the RACH procedure; or
a fifth indicator indicating whether an LTM cell switch without the RACH procedure fallbacks to the LTM cell switch with the RACH procedure.

15. A central unit (CU), comprising:
at least one memory; and
at least one processor coupled with the at least one memory and configured to cause the CU to:
receive, from one or more distributed units (DUs), one or more candidate cell configurations, wherein each DU is associated with a set of candidate cell configurations;
transmit, to a user equipment (UE) via a source DU, information indicating at least one candidate cell configuration for an L1/L2-triggered mobility (LTM) cell switch, wherein each candidate cell is configured with at least one timer associated with a random access channel (RACH) or a RACH-skip for an LTM cell switch.

16. A method performed by a user equipment (UE), the method comprising:
obtaining information indicating at least one candidate cell configuration, wherein each candidate cell is configured with at least one timer associated with a random access channel (RACH) or a RACH-skip;
receiving indication information associated with an L1/L2-triggered mobility (LTM) cell switch to a first candidate cell; and
determining whether to perform an LTM cell switch with a RACH procedure or an LTM cell switch without a RACH procedure to the first candidate cell.

17. The method of claim 16, further comprising:
starting a first timer associated with the RACH to perform the LTM cell switch with the RACH procedure to the first candidate cell.

18. The method of claim 16, further comprising:
starting a second timer associated with the RACH-skip to perform the LTM cell switch without the RACH procedure to the first candidate cell.

19. The method of claim 16, wherein the information includes at least one of the following:
a first indicator indicating whether to apply a stored candidate cell configuration when a candidate cell selected by the UE is an LTM candidate cell after a failure of at least one of the LTM cell switch with the RACH procedure or the LTM cell switch without the RACH procedure;
a first timing advance (TA) value for each candidate cell corresponding to each of the at least one candidate cell configuration; or
a RACH configuration for acquiring a second TA value for each candidate cell corresponding to each of the at least one candidate cell configuration.

20. The method of claim 19, wherein the indication information includes at least one of the following:
a second TA value of the first candidate cell;
a second indicator indicating whether to apply a stored candidate cell configuration when a candidate cell selected by the UE is an LTM candidate cell after a failure of at least one of the LTM cell switch with the RACH procedure or the LTM cell switch without the RACH procedure; or
a third indicator indicating a timer of the at least one timer associated with the RACH or the RACH-skip for the first candidate cell.
